(19) United States
(12) Patent Application Publication
(10) Pub. No.: US 2014/0259409 A1
(43) Pub. Date: Sep. 18, 2014

(54) ELECTRIC BED

(71) Applicants: RUOEY LUNG ENTERPRISE CORP., Lu-Kang Town (TW); PPJ. LLC, Natick, MA (US)

(72) Inventor: Chuan-Hang SHIH, Lu-Kang Town (TW)

(73) Assignees: PPJ. LLC, Natick, MA (US); RUOEY LUNG ENTERPRISE CORP., Lu-Kang Town (TW)

(21) Appl. No.: 13/841,699

(22) Filed: Mar. 15, 2013

(51) Int. Cl. A61G 7/002

(52) U.S. Cl. CPC A61G 7/002
USPC 5/600

(57) ABSTRACT

An electric bed is formed of a bedstead having an immovable base and a movable base pivotably connected with the immovable base, a drive mounted to the bedstead for driving the movable base to pivot relative to the immovable base, and an air bag mounted to the first or second surface and provided with a hole and a sounder mounted into the hole. The immovable base has a first surface facing the movable base. The movable base has a second surface facing the immovable base. The movable base is pivotable between a lying position and an uplift position relative to the immovable base. If a foreign object or the user's body is jammed between the immovable base and the movable base, the air bag will be squeezed to make the sounder sound for warning.

### BACKGROUND OF THE INVENTION

1. Field of the Invention

The present invention relates generally to an electric bed and more particularly, to an electric bed having a warning device.

2. Description of the Related Art

A conventional electric bed includes a movable base and an immovable base where the movable base is pivotable relative to the immovable base for fitting a user's lying posture, so it is suitable to the young people in pursuit of quality life, or patients whose lumbar spines and necks are uncomfortable or who are pneumonic, or some elderly people who fail to lie horizontally. Since such electric bed is adjustable for the inclined angle of the movable base relative to the immovable base, when the movable base is adjusted to return to a horizontal position from an inclined position, if a foreign object, a patient, or a kid is accidentally jammed between the movable base and the immovable base, the electric bed may be damaged or the personnel may get hurt. In particular, many electric beds serve as medical beds and their users are mostly the elderly or the people with handicapped mobility, so the operational safety becomes noticeable. Although some commercially available electric beds include safeguards capable of detecting certain foreign object by means of electric current or invisible light, they are more expensive than the regular ones and thus less popular with most of the users.

### SUMMARY OF THE INVENTION

The primary objective of the present invention is to provide an electric bed, which can enhance safety, simplify manufacture and assembly, and lower the cost.

The foregoing objective of the present invention is attained by the electric bed formed of a bedstead, a drive, and an air bag. The bedstead includes an immovable base and a movable base pivotably connected with the immovable base. The immovable base has a first surface facing the movable base. The movable base has a second surface facing the immovable base. The movable base is pivotable between a lying position and an uplift position relative to the immovable base. When the movable base is located at the lying position, the movable base is substantially parallel to the immovable base and the first surface is adjacent to the second surface. When the movable base is located at the uplift position, the movable base is not parallel to the immovable base. The drive is mounted to the bedstead for driving the movable base to pivot relative to the immovable base. The air bag is mounted to the first or second surface and includes a hole and a sounder mounted into the hole.

In light of the structure mentioned above, when the movable base pivots to the lying position from the uplift position, if some foreign objects or some parts of the user's body are jammed between the movable base and the immovable base, the air bag will be squeezed to make the sounder sound, so it can serve as a warning device. In this way, the present invention does not need high cost but greatly boost the operational safety of the electric bed.

### BRIEF DESCRIPTION OF THE DRAWINGS

FIG. 1 is a partially perspective view of a first preferred embodiment of the present invention.

FIG. 2 is a partially front elevational view of the first preferred embodiment of the present invention.

FIG. 3 is a partially side view of the first preferred embodiment of the present invention.

FIG. 4 is a partially perspective view of a second preferred embodiment of the present invention.

FIG. 5 is a perspective view of a third preferred embodiment of the present invention.

FIG. 6 is a partially perspective view of a fourth preferred embodiment of the present invention.

FIG. 7 is a partially front elevational view of the fourth preferred embodiment of the present invention.

FIG. 8 is a partially side view of the fourth preferred embodiment of the present invention.

### DETAILED DESCRIPTION OF PREFERRED EMBODIMENTS

Structural features and desired effects of the present invention will become more fully understood by reference to four preferred embodiments given hereunder. However, it is to be understood that these embodiments are given by way of illustration only, thus are not limitative of the claim scope of the present invention.

Referring to FIGS. 1-3, an electric bed 100 constructed according to a first preferred embodiment of the present invention is formed of a bedstead 10, a drive 20, and an air bag 30. The detailed descriptions and operations of these elements as well as their interrelations are recited in the respective paragraphs as follows.

The bedstead 10 includes an immovable base 12 and a movable base 14, which are pivotably connected with each other via a pivotal member 16 for pivoting to a proper position for compliance with the user's need. If the user intends to horizontally lie down on the electric bed 100 for rest, the user can adjust the movable base 14 to a lying position P1 which is almost horizontal and meanwhile, the movable base 14 is substantially parallel to the immovable base 12. If the user intends to lie on the electric bed 100 with sitting posture for eating food or watching television, the user can change the movable base 14 to an uplift position P2 and meanwhile, the movable base 14 counterclockwise pivots to be inclined relative to the immovable base 12. An inclination angle defined between the movable base 14 and the immovable base 12 may differ from the inclination angle illustrated in this preferred embodiment as long as it fulfills the condition that the movable base 14 is not parallel to the immovable base 12.

The immovable base 12 includes a first surface 121 facing an imaginary plane on which the movable base 14 is located. The movable base 14 includes a second surface 141 facing an imaginary plane on which the immovable base 12 is located. When the movable base 14 is located at the lying position P1, the first surface 121 is adjacent to the second surface 141. It needs to be emphasized that the first surface 121 is not any of the surfaces (namely the surfaces of the immovable 12 that face upward as shown in FIG. 1) of the immovable base 12 that face the imaginary plane on which the movable base 14 is located; only when the movable base 14 is located at the lying position P1, what is adjacent to the second surface 141 is the first surface 121 defined in the present invention; on the contrary, as shown in FIG. 1, the surface indicated by the arrow with reference sign A shall not be treated as the first surface 121 defined in the present invention. Similarly, the second surface 141 is not any of the surfaces (namely the surfaces of the movable base 14 that face downward as shown in FIG. 1) of the movable base 14 that face the imaginary plane on which the immovable base 12 is located; only when the movable base 14 is located at the lying position P1, what is adjacent to the first surface 121 is defined as the second surface 141 in the present invention.

The drive 20 is mounted between the immovable base 12 and the movable base 14 for driving the movable base 14 to pivot relative to the immovable base 12. The user can change the inclination angle of the movable base 14 as per his or her need to enable the movable base 14 to pivot between the lying position P1 and the uplift position P2.

The air bag 30 is mounted to the second surface 141 of the movable base 14 and includes a hole 32 and a sounder 34 mounted into the hole 32. When the air bag 30 is squeezed, the air can pass through the sounder 34 to make it sound. It is to be understood that the size, shape, and number of the air bag are changeable as per the actual need and not limited to what is shown in FIGS. 1 and 2.

It is to be noted that as shown in FIG. 1, the first surface 121 adjacent to the pivotal member 16 does not right aim at the second surface 141, i.e. they face each other with an offset, so when the movable base 14 is located at the lying position P1 shown in FIG. 2, the first surface 121 and the second surface 141 are not superposed on each other but are located side by side as shown in FIG. 3. In other words, as shown in FIG. 3, if the bedstead 10 of the electric bed 100 in accordance with the first preferred embodiment of the present invention is operated normally and none of any foreign object or any people is jammed between the movable base 14 and the immovable base 12, when the user moves the movable base 14 to the lying position P1 from the uplift position P2, the air bag 30 will not be squeezed.

Referring to FIG. 2, when the movable base 14 pivots to the lying position P1 from the uplift position P2, the second surface 141 gradually approaches the first surface 121. If some foreign object or person is jammed between the movable base 14 and the immovable base 12, the air bag 30 will be squeezed to make the sounder 34 sound to serve as a warning device. Compared with the warning device mounted to the conventional electric bed for detecting some foreign object via the electric current or invisible light, the warning device of the present invention is simpler in structure and assembly and more low-cost to boost the operational safety of the electric bed.

Referring to FIG. 4, an electric bed constructed according to a second preferred embodiment of the present invention is similar to and differs from that of the first preferred embodiment in that the movable base 14 of the first preferred embodiment only includes a movable framework 143 and the electric bed of the second preferred embodiment additionally includes a bed plate 145 mounted onto the movable framework 143 and located away from the immovable base 12. The air bag 30 is mounted to the bed plate 14 and right faces the first surface 121. When the movable base 14 is located at the lying position P1, a gap is formed between the bed plate 145 and the first surface 121 for receiving the air bag 30, so the air bag 30 will not be squeezed to make the sounder sound in the process of the normal operation.

When the movable base 14 pivots clockwise to the lying position P1 from the uplift position P2, if some foreign object or the user's body is jammed between the movable base 14 and the immovable base 12, the air bag 30 will be squeezed to make the sounder 34 sound to achieve the same warning effect.

In addition, as shown in FIG. 5, an electric bed constructed according to a third preferred embodiment of the present invention is similar to that of the second preferred embodiment and differs in that the immovable base 12 of the third preferred embodiment further includes an immovable framework 123 and a bed frame 125 mounted to a peripheral edge of the immovable framework 123. Referring to FIG. 5 again, the bed frame 125 belongs to a part of the immovable base 12, so the bed frame 125 also includes the first surface 121 facing an imaginary plane on which the movable base 14 is located. In this embodiment, two air bags 30 are mounted to the first surface 121 of the bed frame 125 and the second surface 141, which is located at bottom surface of the bed plate 145 and adjacent to the bed frame 125, respectively. The first surface 121 and the second surface 141 do not right aim at each other though they face each other. In this way, the same warning effect can also be attained. However, the air bag 30 mounted to the first surface 121 tends to be accidentally squeezed by the user or a third party (sitting at one side of the bed) to make the sounder sound, so the air bag 30 should be preferably mounted on the bottom surface of the bed plate 145 and adjacent to the bed frame 125 according to the practical operational convenience if the bed frame 125 is available.

Referring to FIG. 6, an electric bed 100′ constructed according to a fourth preferred embodiment of the present invention is similar to those of the aforesaid two preferred embodiments, e.g. the immovable base 12′ and the movable base 14′ are pivotably connected with each other via the pivotal member 16′, and the movable base 14′ includes the movable framework 143′ and the bed plate 145′. In this preferred embodiment, the air bag 30′ is mounted on the movable framework 143′ and faces the immovable base 12′. When the movable base 14′ pivots from the uplift position P′2 to the lying position P′1, the movable base 14′ is superposed on the immovable base 12′ rather than side by side. In the meantime, the first surface 121′ is located on the immovable base 12′ and the second surface 141′ is located on the bottom surface of the movable base 14′. The first surface 121′ actually right aims at the second surface 141′; namely, the first surface 121′ and the second surface 141′ are superposed on each other vertically rather than side by side. Referring to FIGS. 7 and 8, a gap 40′ is formed between the first and second surfaces 121′ and 141′ for accommodating the air bag 30′. In the process of normal operation, when the user makes the movable base 14′ return to the lying position P′1 from the uplift position P′2, the air bag 30′ is not squeezed. When some foreign object or the user's body is jammed between the movable base 14′ and the immovable base 12′, the air bag 30′ is squeezed to make the sounder to sound.

What is claimed is:

1. An electric bed comprising:
a bedstead having an immovable base and a movable base pivotably connected with the immovable base, the immovable base having a first surface facing the movable base, the movable base having a second surface facing the immovable base, the movable base being pivotable relative to the immoveable base between a lying position where the movable base is substantially parallel to the immovable base and the first surface is adjacent to the second surface, and an uplift position where the movable base is not parallel to the immovable base;
a drive mounted to the bedstead for driving the moveable base to pivot relative to the immoveable base; and
an air bag mounted to one of the first surface and the second surface and having a hole and a sounder mounted into the hole.

2. The electric bed as defined in claim 1, wherein when the movable base is located at the lying position, the first surface does not right aim at the second surface.

3. The electric bed as defined in claim 1, wherein the movable base comprises a movable framework.

4. The electric bed as defined in claim 3, wherein the movable base comprises a bed plate disposed on a side of the movable framework away from the immovable base.

5. The electric bed as defined in claim 4, wherein the air bag is mounted to the bed plate.

6. The electric bed as defined in claim 4, wherein the immovable base comprises an immovable framework.

7. The electric bed as defined in claim 6, wherein the immovable base comprises a bed frame mounted to a peripheral edge of the immovable framework.

8. The electric bed as defined in claim 1, wherein the immovable base comprises an immovable framework.

9. The electric bed as defined in claim 8, wherein the immovable base comprises a bed frame mounted to a peripheral edge of the immovable framework.

10. The electric bed as defined in claim 1, wherein when the movable base is located at the lying position, the first surface substantially right aims at the second surface, and a gap is formed between the first surface and the second surface for receiving the air bag.
